(19) United States
(12) Patent Application Publication
(10) Pub. No.: US 2016/0117324 A1
(43) Pub. Date: Apr. 28, 2016

(54) RANKING LABELED INSTANCES EXTRACTED FROM TEXT

(71) Applicant: Marius A Pasca, Sunnyvale, CA (US)

(72) Inventor: Marius A Pasca, Sunnyvale, CA (US)

(73) Assignee: GOOGLE INC., Mountain View, CA (US)

(21) Appl. No.: 13/105,679

(22) Filed: May 11, 2011

(51) Int. Cl. G06F 17/30; G06N 99/00

(52) U.S. Cl. CPC G06F 17/3053; G06F 17/30598; G06N 99/005

(57) ABSTRACT

Technologies for development of IsA repositories are described that can be applied to the interpretation of text by computing devices in a variety of settings. The use of features other than those computed over an underlying document collection, such as popularity in search queries of the terms in class labels, is described, for the purpose of determining, or improving, the relative ranking of various class labels, given a class instance.

### BACKGROUND OF THE INVENTION

A tool known as an “IsA” repository has been used to support computer-based interpretation of text, for ranking and refining search results, for example, and for other purposes. IsA repositories are used to map class labels to instances, where the class labels and the instances are strings occurring in the text. Classes pertaining to unrestricted domains (e.g., west african countries, science fiction films, slr cameras) which can be mapped to their instances (cape verde, avatar, canon eos 7d) play a disproportionately important role in Web search. They occur prominently in Web documents and among search queries submitted most frequently by Web users. They also serve as building blocks in formal representation of human knowledge, and are useful in a variety of text processing tasks. IsA repositories are one tool used for processing text in this manner.

In the automatic offline acquisition of fine-grained, labeled classes of instances to form an IsA repository, some of the extracted class labels are inevitably less useful (works) or spurious (car makers) for an associated instance (avatar).

In web search, the relative ranking of documents returned for a query directly affects the outcome of the search. Similarly, the relative ranking among class labels extracted for a given instance as can be done using IsA repositories, influences many applications using the class labels. It is desirable to provide technology that can improve the usefulness of such rankings.

### SUMMARY

The present invention relates the development of rankings for classes associated with a given instance that can be applied to the interpretation of text by computing devices in a variety of settings. The use of features other than those computed over an underlying document collection, such as popularity in a training set of search queries, of the terms in the class labels, is described for the purpose of determining, or improving, the relative ranking of various class labels given an instance.

In this description, an “instance” is a text string including one or more terms, typically a word or phrase, which could occur in a search query in an Internet search engine. A “class” is a class label than can be applied to the instance I. A class label can also be a text string including one or more terms, typically a word or phrase.

An instance:class association I:C is a data structure that links a class with an instance, and can be made by manually coding the associations, by using extraction pattern-based analysis of web documents, and by the use of other technologies. In one data structure example, a class C is associated with an instance I if it is a member of a set or list of classes assigned as attributes of the instance I in a database, whereby each class C in the list or set is associated with the instance I. Also, a group of instance:class associations I:C for a given instance I can comprise a data structure including a linked list of classes mapped to the given instance I, whereby each class C in the linked list is associated with the instance I. In another example, an instance:class association I:C can comprise a data structure embodied in a parsable electronic document coded using a markup language, like XML, HTML, and SGML. An IsA repository is a data structure that includes a number of such instance:class associations I:C, in which the instance:class associations I:C can be ranked for given instance I, using the technology described herein.

### BRIEF DESCRIPTION OF THE DRAWINGS

FIG. 1 is a high level block diagram of a computer system configured for processing instance:class associations as described herein.

FIG. 2 is a simplified diagram of a memory storing an IsA repository including ranked instance:class associations produced as described herein.

FIG. 3 is a simplified diagram of a computer program product storing executable instructions containing logic for processing instance:class associations as described herein.

FIG. 4 is a simplified flowchart of a computer implemented process for ranking and re-ranking instance:class associations as described herein.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

A technology is described here for producing an IsA repository that can take advantage of the co-occurrence of a class and an instance within search queries from a training set of queries, such as anonymized query logs from an Internet search engine. The classes can be associated with instances using extraction pattern technology, using manual processes, or otherwise. The lists of classes associated with an instance can be re-ranked to promote classes that co-occur with the instance in the queries of the training set.

The technology can be used for the ranking of candidate extractions (i.e. instance:class associations) so that the less relevant ones are ranked lower, as opposed to removed when deemed unreliable based on various clues. The accuracy of the associations of classes with instances, and of the ranking of the classes associated with a given instance, achieved using the present technology, exceeds that of previous work, over evaluation sets of instances associated with Web search queries.

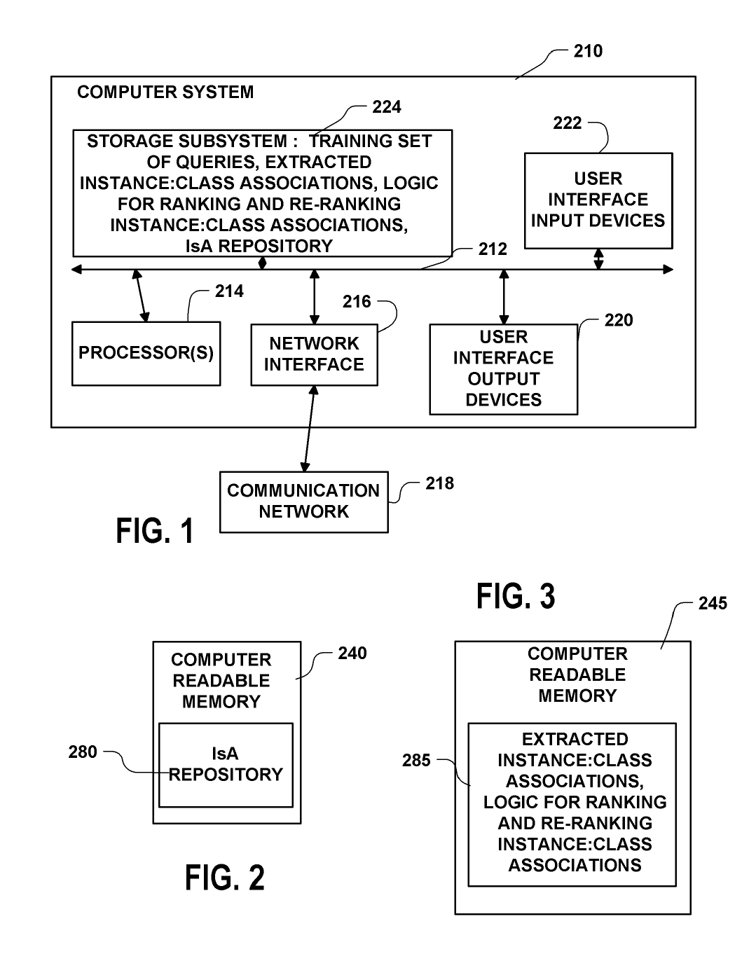

FIG. 1 is a simplified block diagram of a computer system 210 suitable for use with embodiments of the technology. Computer system 210 typically includes at least one processor 214 which communicates with a number of peripheral devices via bus subsystem 212. These peripheral devices may include a storage subsystem 224, comprising for example memory devices and a file storage subsystem, user interface input devices 222, user interface output devices 220, and a network interface subsystem 216. The input and output devices allow user interaction with computer system 210. Network interface subsystem 216 provides an interface to outside networks, including an interface to communication network 218, and is coupled via communication network 218 to corresponding interface devices in other computer systems. Communication network 218 may comprise many interconnected computer systems and communication links. These communication links may be wireline links, optical links, wireless links, or any other mechanisms for communication of information. While in one embodiment, communication network 218 is the Internet, in other embodiments, communication network 218 may be any suitable computer network.

User interface input devices 222 may include a keyboard, pointing devices such as a mouse, trackball, touchpad, or graphics tablet, a scanner, a touchscreen incorporated into the display, audio input devices such as voice recognition systems, microphones, and other types of input devices. In general, use of the term “input device” is intended to include all possible types of devices and ways to input information into computer system 210 or onto communication network 218.

User interface output devices 220 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 210 to the user or to another machine or computer system.

Storage subsystem 224 stores the basic programming and data constructs that provide the functionality of some or all of the tools described herein, including the logic for storing a training set of queries and extracted instance:class associations, and including logic for ranking and re-ranking instance:class associations utilizing the training set in one of the ranking and re-ranking steps. The storage subsystem can also store an IsA repository that is compiled according to the processes described herein. The storage subsystem can also store programming and data constructs for applying the IsA repository in processing text, including mapping instance:class associations to text representing natural language, and to rank classes associated with instances extracted from the text. These software modules are generally executed by processor 214 alone or in combination with other processors.

Memory used in the storage subsystem can include a number of memories including a main random access memory (RAM) for storage of instructions and data during program execution and a read only memory (ROM) in which fixed instructions are stored. A file storage subsystem can provide persistent storage for program and data files, and may include a hard disk drive, a floppy disk drive along with associated removable media, a CD-ROM drive, an optical drive, or removable media cartridges. The databases and modules implementing the functionality of certain embodiments may be stored by file storage subsystem in the storage subsystem 224, or in other machines accessible by the processor.

Bus subsystem 212 provides a mechanism for letting the various components and subsystems of computer system 210 communicate with each other as intended. Although bus subsystem 212 is shown schematically as a single bus, alternative embodiments of the bus subsystem may use multiple busses.

Computer system 210 can be of varying types including a personal computer, a portable computer, a workstation, a computer terminal, a network computer, a television, a mainframe, or any other data processing system or computing device. Due to the ever-changing nature of computers and networks, the description of computer system 210 depicted in FIG. 1 is intended only as a specific example for purposes of illustrating the preferred embodiments. Many other configurations of computer system 210 are possible having more or less components than the computer system depicted in FIG. 1.

FIG. 2 illustrates a product storing an IsA repository 280 including a number of ranked lists of instance:class associations produced according to the technology described herein, in a computer readable memory 240. The memory 240 can comprise a medium for example associated with file storage subsystem 224, and/or with network interface subsystem 216, or can comprise a data storage medium in a separate device. The medium used for the computer readable memory 240 can be a non-transitory medium, such as a hard disk, a floppy disk, a CD-ROM, an integrated circuit memory device, an optical medium, and removable media cartridge. An IsA repository produced as described herein can also be embodied by data coded on a transitory medium, such as a radio communication channel.

FIG. 3 illustrates a computer program product according to the technology described herein. The computer program product includes a computer readable memory 245 which is shown storing computer instructions 285 executable by a computing device that includes logic according to the technology described herein, for storing a training set of queries and extracted instance:class associations, and including logic for ranking and re-ranking instance:class associations utilizing the training set in one of the ranking and re-ranking steps. The computer readable memory 245 can be a medium for example associated with file storage subsystem 228, and/or with network interface subsystem 216, or be a separate memory device. The medium used for the computer readable memory can be a non-transitory medium, such as a hard disk, a floppy disk, a CD-ROM, an optical medium, and removable media cartridge. A computer program product as described herein can also be embodied by instructions coded on a transitory medium, such as a radio communication channel.

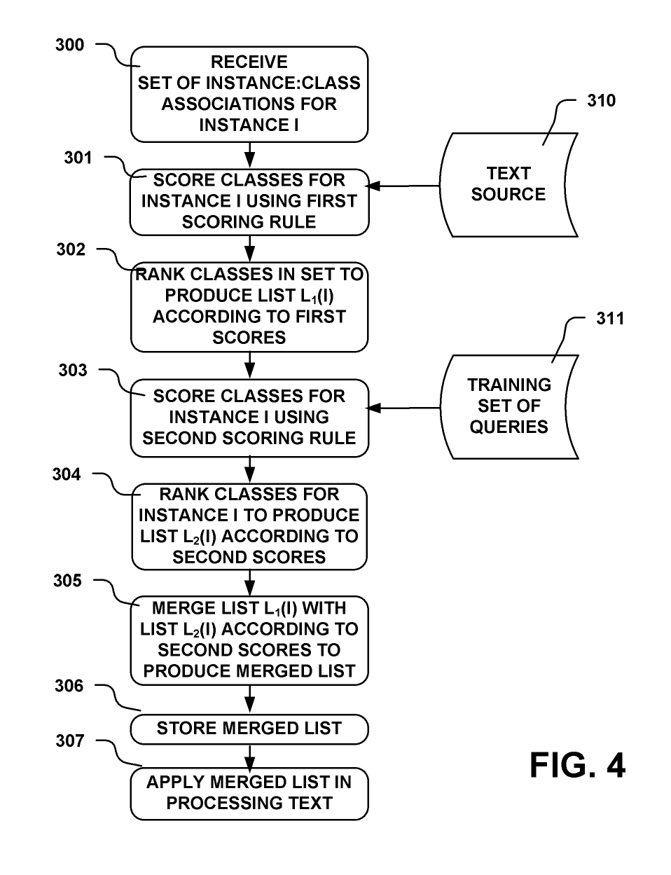

FIG. 4 is a basic flowchart for a process for ranking and re-ranking instance:class associations.

For a process reflected in FIG. 4, a set of instance:class associations which may be unranked, is provided as input (300). The input set of instance:class associations can be derived for example from a text source using the extraction pattern technology. In a next step, the classes associated with a given instance I are scored using a first scoring rule (301). The first scoring rule can be based on processing a text source 310, which may or may not be the same text source from which the instance:class associations in the input set were derived. After computing scores according to the first scoring rule, the classes in the set are ranked to produce a ranked list L₁(I) according to the first scores (302). In one embodiment, a first ranked list L₁(I) of instance:class associations (I:C) is provided as input to a process to re-rank the list, where steps 300-302 may be performed externally or other technology may be used to produce the first ranked list L₁(I).

The rank of a particular instance:class association in the ranked list L₁(I) can be assigned using a scoring formula.

A scoring formula can be applied by a computing device executing a computer program over a text source 310, such as a library of Web documents that includes unstructured text and search queries. The collection of queries could be a sample of a large number of unique, fully-anonymized queries in English submitted by Web users in a selected time period, such as the year 2009. Each query can be accompanied by its frequency of occurrence in the logs associated with the library. The document collection could consist for example of a sample of a large number of documents in English. The textual portion of the documents could be cleaned of HTML, tokenized, split into sentences and part-of-speech tagged using known part-of-speech tagger processes operating over sentences from text.

For example, a score Score(I:C) for a particular instance:class association can be calculated by a scoring formula, such as the following:

Score(I:C)=Size({Pattern(I:C)})²×Freq(I:C)

A computing device can be used to determine the square of the size (i.e. number of members) of the set of extraction patterns that return the particular instance:class association (Size({Pattern (I:C)})2); to determine the frequency of occurrence (Freq(I:C)) of the instance:class association in the source, and to multiply these numbers to generate a score for each instance:class association. Using these calculated scores, a computer program can produce a ranked list of instance:class associations.

The ranked list L₁(I) can be ranked using the formula set out above, or by other ranking processes. In addition, rather than a ranked list, an input to the ranking process described next can be a set of entries without initial ranking.

This input list L₁(I) is processed next to change the ranking of instance:class associations, and to score the instance:class associations according to a second scoring rule (303). The second scoring rule can compute scores based on information derivable from a training set of queries 311. For example, the scores can be determined according to the popularity of class terms in queries in the training set. The training set 311 can comprise a repository of anonymized queries.

The second scoring rule can be executed over the instance:class associations in the first list L₁(I). For example a computing device executing a computer program can be used to compute a score for a given class Cᵢ, that contains a set of terms Tⱼ (ignoring terms classified as stop words), by determining a subset Q of queries from the repository, whose members Qₖ contain the instance I within the query, and contain the term Tⱼ within the query. In one embodiment, the subset Q of queries is further constrained by requiring that the members Qₖ must contain the instance I as a prefix in the query (i.e. occur as the first word or phrase in the query), and must contain the term Tⱼ anywhere else in the query (i.e. not in the prefix formed by the instance I). These combinations of constraints filter for queries that might arise in a query entered, for example, by a user who formulates the query using the instance I as a first word or phrase, and then refines the query by adding terms that can be part of a class label.

Using this subset Q, the frequency of each term Tⱼ of class Cᵢ in the subset is determined. Then, each instance:class association is assigned a score by applying an appropriate statistical function over the frequencies in the subset Q of the terms of the class C. In one example, the statistical function is the geometric mean of the frequencies of the Tⱼ in class Cᵢ, again ignoring stop words. An alternate statistical function could be a median, for example. As a result, scores are assigned to instance:class associations that are weighted in favor of classes that include individual terms occurring in popular queries containing the instance.

A computer program for processing a list to change the ranking of instance:class associations in the list according to the popularity of class terms in queries, can have a logical structure set out in pseudocode, as follows:

```
I = an instance
L_I = input ranked list of class labels of the
instance I
Q = collection (set) of Web search queries
# Scan class labels of instance I
for class label C_i in L_I:
  num_terms = 0.
  # Scan terms of class label
  for term T_j of C_i:
    # Compute frequency of current term, over queries
    # starting with the instance I
    S_j = Sum_k(Freq(T_j, Q_k),
      such that Prefix(Q_k, I),
      where k=1..number of queries in Q.
    num_terms++.
  # Compute score of class label, as geometric mean
  # of scores of individual terms
  S_i = Product(S_j, with j=1..num_terms) \hat{ }
(1/num_terms).
Re-rank class labels C_i of L_I, based on scores S_i,
with i=1..length(L_I).
```

A second list L₂(I) can be produced, using the scores produced according to the popularity of class terms in queries, to assign ranks to the instance:class associations (304). In the case of a tie, then the rank of the tied instance:class associations can be adjusted, according to a suitable rule. In one embodiment, the tied instance:class associations have their scores adjusted to preserve the relative rank from the input list L₁(I).

Next, a merged list can be produced (305) to reduce noise that may occur using a ranking based solely on popularity of class terms in queries. Relying on query logs to estimate the relevance of class labels can expose the ranking method to significant noise. On one hand, arguably useful class labels (e.g., authors) may not occur in queries along with the respective instances (diderot). On the other hand, for each query containing an instance and terms from useful class labels, there are many other queries containing, for example attributes in the query (diderot biography or diderot beliefs), or the name of a book in the query (diderot the nun). Therefore, the ranked list L₂(I) in some embodiments may be too noisy to be used directly as rankings in an IsA repository or other tool applying class rankings to instances.

In one example, a merged list can be produced by a process that assigns a score based on a function of the ranks of the classes in the first list L₁(I), or another ranked list, relative to the ranks of classes in the second list L₂(I). In other embodiments, more than two ranked lists can be merged. One function that can be used to merge the first and second lists, can be characterized as follows:

MergedScore(I,C)=2/(Rank(I:C,L₁)+Rank(I:C,L₂))

This function operates to compute a score for an instance:class association I:C, that results in a new ranking in decreasing order of the inverse of the average rank (instance:class associations in the list L₁ and L₂ that have a higher rank will tend to have a lower MergedScore). The number “2” in the example formula corresponds to the number of lists being merged, which in this case is 2. The term Rank(I:C, Li) is the rank of the instance:class association for class C in list Li. The rank is set to a high number, such as 1000, if the class does not occur in the list Li. In the case of ties in the merged ranking, the scores of one of the lists can be used as a secondary ranking criterion. In one example, the scores for the first list L₁(I) are used for this secondary ranking criterion.

Next, the merged list is stored (306). The merged list is a new list of instance:class associations usable in an IsA repository. By using only the relative ranks of the class labels within the input lists, and not on their scores, the outcome of the merging is less sensitive to how class labels of a given instance are scored.

As a final step in the process shown FIG. 4, the merged list can be applied in processing text (307), including natural language text.

The technology described herein includes a method that can be performed by a computing device. One method according to this technology processes instance:class associations, in which the instances comprise text, and the classes comprise text labels for the instances, for use in analysis of language by a computing device. This method comprises computing scores for classes in a set of classes associated with a given instance, the score for a particular class based upon occurrence in a set of queries of a term or terms in the particular class and occurrence in the set of queries of the given instance. The computing device can then store a ranking of instance:class associations for the given instance in memory, the ranking based on the scores. In an example, the process of computing scores for classes includes, for a given class Cᵢ, that contains a set of terms Tⱼ, determining a subset of queries Q from the set of queries, whose members Qₖ contain the text of the given instance I within the query, and contain the term Tⱼ within the query; computing a frequency of each term Tⱼ of class Cᵢ in the subset of queries Q; and assigning a score by applying a statistical function, such as a geometric mean, over the frequency of the terms of the class Cᵢ.

In one example, the subset of queries Q over which the score is determined, is further constrained by requiring that the members Qₖ contain the instance I as a prefix in the query, and contain the term Tⱼ outside of the prefix in the query.

A method is also provided which includes merging a first ranked list of instance:class associations for the given instance with the stored ranking for the given instance, produced using the process above, to produce merged scores for the set of classes associated with the given instance I. A computing device can store a changed ranking of instance:class associations for the given instance based on the merged scores. The changed ranking based on the merged scores can be applied to associate classes with instances derived from processing text.

In another example, a method is provided that includes:
processing a set of instance:class associations I:C to produce a first ranked list L₁(I) for the given instance I, and wherein the stored ranking mentioned above comprises a second ranked list L₂(I) for the given instance I;
merging the first ranked list and the second ranked list to produce merged scores for the set of classes associated with the given instance I; and
storing a changed ranking of instance:class associations for the given instance based on the merged scores.

The first ranked list can be produced by determining the square of a size of a set of extraction patterns that return the particular instance:class association (Size{Pattern (I:C)})2 over a text source; determining a frequency of occurrence (Freq(I:C)) of the instance:class association in the text source; and multiplying the square of the size by the frequency to generate a score for each instance:class association for the given instance.

My publication, Pasca, “The Role of Queries in Ranking Labeled Instances Extracted from Text,” Coling 2010: Poster Volume, August, 2010, pages 955-962, is incorporated by reference as if fully set forth herein.

The technology disclosed herein can be implemented by a product that comprises a memory storing the rankings of instance:class associations produced using the processes described herein.

The technology disclosed also may be practiced as a computer program product or an article of manufacture. This article of manufacture includes a non-transitory memory that stores computer instructions. In one implementation, the computer instructions, when run on suitable hardware, perform any of the methods described herein. In another implementation, the computer instructions, when combined with suitable hardware, produce the devices described.

I claim as follows:

1-23. (canceled)

24. A method for use in analysis of language by a computing device, comprising:
identifying a class and a second class associated with an instance, the instance having an IsA relationship to the class and having a second IsA relationship to the second class;
identifying at least one instance term associated with the instance and one or more class terms associated with the class, the one or more class terms being a text label for the class;
identifying a training set of queries;
computing a score for the IsA relationship of the instance to the class based on a frequency of co-occurrence in the queries of the training set, wherein the frequency of co-occurrence indicates frequency, in the training set, of the queries that include both: the at least one instance term as a query prefix and the one or more class terms outside of the query prefix;
identifying one or more second class terms associated with the second class, the one or more second class terms being a text label for the second class;
computing a second score for the second IsA relationship of the instance to the second class based on a second frequency of co-occurrence in the queries of the training set, wherein the second frequency of co-occurrence indicates frequency, in the training set, of the queries that include both: the at least one instance term as a query prefix and the one or more second class terms outside of the query prefix;
determining, based on the score for the IsA relationship of the instance to the class and the second score for the additional IsA relationship of the instance to the second class, a ranking of the IsA relationship of the instance to the relative to the second IsA relationship of the instance to the second class; and
storing the ranking of the IsA relationship of the instance to the class relative to the second IsA relationship of the instance to the second class.

25. (canceled)

26. The method of claim 24, wherein computing the score for the IsA relationship of the instance to the class includes:
determining an additional frequency of co-occurrence, in the queries of the training set, wherein the additional frequency of co-occurrence indicates frequency, in the training set, of the queries that include both: the at least one instance term and one or more additional class terms associated with the class, the one or more additional class terms being an additional text label for the class; and
computing the score for the class by applying a statistical function over the frequency of co-occurrence and the additional frequency of co-occurrence.

27. The method of claim 26, wherein the statistical function comprises a geometric mean.

28. The method of claim 24, wherein computing the score for the IsA relationship of the instance to the class includes:
determining an additional frequency of co-occurrence, in the queries of the training set, wherein the additional frequency of co-occurrence indicates frequency, in the training set, of the queries that include both: the at least one instance term as the prefix and one or more additional class terms outside the prefix, the one or more additional class terms associated with the class and being an additional text label for the class; and
computing the score for the class by applying a statistical function over the frequency of co-occurrence and the additional frequency of co-occurrence.

29. The method of claim 24, wherein the one or more class terms include only non-stop words.

30. The method of claim 24, further comprising:
merging a first ranking of the IsA relationship of the instance to the class relative to the second IsA relationship of the instance to the second class with the stored ranking of the IsA relationship of the instance to the class relative to the second IsA relationship of the instance to the second class to produce a merged ranking of the IsA relationship of the instance to the class relative to the second IsA relationship of the instance to the second class; and
storing the merged ranking of the IsA relationship of the instance to the class relative to the second IsA relationship of the instance to the second class.

31. The method of claim 30, further comprising:
applying the merged ranking of the IsA relationship of the instance to the class relative to the second IsA relationship of the instance to the second class to associate the class with the instance in processing of text.

32. The method of claim 24, further comprising:
processing a set of instance:class associations and instance:second class associations to produce a first ranking of the IsA relationship of the instance to the class relative to the second IsA relationship of the instance to the second class;
merging the first ranking and the stored ranking to produce a merged ranking of the IsA relationship of the instance to the class relative to the second IsA relationship of the instance to the second class; and
storing the merged ranking.

33. The method of claim 32, further comprising: applying the merged ranking to associate the class with the instance in processing of text.

34. The method of claim 32, further comprising:
determining the first ranking of the IsA relationship of the instance to the class relative to the second IsA relationship of the instance to the second class based on a frequency of occurrence of an association of the class with the instance in Web documents.

35. A data processing system for use in analysis of language by a computing device, comprising:
a processor including memory, and instructions executable by the processor stored in the memory, comprising logic to:
identify a class and a second class associated with an instance, the instance having an IsA relationship to the class and having a second IsA relationship to the second class;
identify at least one instance term associated with the instance and one or more class terms associated with the class, the one or more class terms being a text label for the class;
identify a training set of queries;
compute a score for the IsA relationship of the instance to the class based on a frequency of co-occurrence in the queries of the training set, wherein the frequency of co-occurrence indicates frequency, in the training set, of the queries that include both: the at least one instance term as a query prefix and the one or more class terms outside of the query prefix;
identify one or more second class terms associated with the second class, the one or more second class terms being a text label for the second class;
compute a second score for the second IsA relationship of the instance to the second class based on a second frequency of co-occurrence in the queries of the training set, wherein the second frequency of co-occurrence indicates frequency, in the training set, of the queries that include both: the at least one instance term as a query prefix and the one or more second class terms outside of the query prefix;
determine, based on the score for the IsA relationship of the instance to the class and the second score for the additional IsA relationship of the instance to the second class, a ranking of the IsA relationship of the instance to the class relative to the second IsA relationship of the instance to the second class and
store the ranking of IsA relationship of the instance to the class relative to the second IsA relationship of the instance to the second class.

36. (canceled)

37. The system of claim 35, wherein said logic to compute the score for the IsA relationship of the instance to the class includes logic to:
determine an additional frequency of co-occurrence, in the queries of the training set, wherein the additional frequency of co-occurrence indicates frequency, in the training set, of the queries that include both: the at least one instance term and one or more additional class terms associated with the class, the one or more additional class terms being an additional text label for the class; and
compute the score for the class by applying a statistical function over the frequency of co-occurrence and the additional frequency of co-occurrence.

38. The system of claim 37, wherein the statistical function comprises a geometric mean.

39. The system of claim 35, wherein said logic to compute the score for the IsA relationship of the instance to the class includes logic to:
determine an additional frequency of co-occurrence, in the queries of the training set, wherein the additional frequency of co-occurrence indicates frequency, in the training set, of the queries that include both: the at least one instance term as the prefix and one or more additional class terms outside the prefix, the one or more additional class terms associated with the class and being an additional text label for the class; and
compute the score for the class by applying a statistical function over the frequency of co-occurrence and the additional frequency of co-occurrence.

40. The system of claim 35, wherein the one or more class terms include only non-stop words.

41. The system of claim 35, wherein the instructions further comprise logic to:
merge a first ranking of the IsA relationship of the instance to the class relative to the second IsA relationship of the instance to the second class with the stored ranking of the IsA relationship of the instance to the class relative to the second IsA relationship of the instance to the second class to produce a merged ranking of the IsA relationship of the instance to the class relative to the second IsA relationship of the instance to the second class; and
store the merged ranking of the IsA relationship of the instance to the class relative to the second IsA relationship of the instance to the second class.

42. The system of claim 41, wherein the instructions further comprise logic to:
apply the merged ranking of the IsA relationship of the instance to the class relative to the second IsA relationship of the instance to the second class to associate the class with the instance in processing of text.

43. The system of claim 35, wherein the instructions further comprise logic to:
process a set of instance:class associations and instance:second class associations to produce a first ranking of the IsA relationship of the instance to the class relative to the second IsA relationship of the instance to the second class;
merge the first ranking and the stored ranking to produce a merged ranking of the IsA relationship of the instance to the class relative to the second IsA relationship of the instance to the second class; and
store the merged ranking.

44. The system of claim 43, wherein the instructions further comprise logic to:
apply the merged ranking to associate the class with the instance in processing of text.

45. The system of claim 43, wherein the instructions further comprise logic to:
determine the first ranking of the IsA relationship of the instance to the class relative to the second IsA relationship of the instance to the second class based on a frequency of occurrence of an association of the class with the instance in Web documents.

46. A computer program product, comprising a memory storing instructions executable by a processor comprising logic to:
identify at least one instance term associated with the instance and one or more class terms associated with the class, the one or more class terms being a text label for the class;
identify a training set of queries;
compute a score for the IsA relationship of the instance to the class based on a frequency of co-occurrence in the queries of the training set, wherein the frequency of co-occurrence indicates frequency, in the training set, of the queries that include both: the at least one instance term as a query prefix and the one or more class terms outside of the query prefix;
identify one or more second class terms associated with the second class, the one or more second class terms being a text label for the second class;
compute a second score for the second IsA relationship of the instance to the second class based on a second frequency of co-occurrence in the queries of the training set, wherein the second frequency of co-occurrence indicates frequency, in the training set, of the queries that include both: the at least one instance term as a query prefix and the one or more second class terms outside of the query prefix;
determine, based on the score for the IsA relationship of the instance to the class and the second score for the additional IsA relationship of the instance to the second class, a ranking of the IsA relationship of the instance to the class relative to the second IsA relationship of the instance to the second class; and
store the ranking of IsA relationship of the instance to the class relative to the second IsA relationship of the instance to the second class.
